(19) United States
(12) Patent Application Publication
(10) Pub. No.: US 2008/0281638 A1
(43) Pub. Date: Nov. 13, 2008

(54) METHOD AND APPARATUS FOR TRACKING, DOCUMENTING, AND PREDICTING FALL-RELATED ACTIVITIES

(75) Inventors: Jonathan Weatherly, Chicago, IL (US); Keith Knohl, Evanston, IL (US)

Correspondence Address: BELL, BOYD & LLOYD, LLP, P.O. Box 1135, CHICAGO, IL, 60690, US

(73) Assignee: Your Choice Living, Inc., Northfield, IL (US)

(21) Appl. No.: 12/115,671

(22) Filed: May 6, 2008

Related U.S. Application Data
(60) Provisional application No. 60/916,471, filed on May 7, 2007.

(51) Int. Cl. G06Q 50/00

(52) U.S. Cl. 705/3

(57) ABSTRACT

The system and methods disclosed enable health-care providers to more accurately predict, monitor, report, and organize health-care events for a plurality of patients. Each patient is provided a fall-detecting device configured to transmit a message indicative of a patient status to a host device maintained by a health-care provider. When the host device receives such a message, the host device creates and stores new patient status data and suitably communicates the information contained in the message to a user. Additionally, the host device generates and automatically populates certain data fields in a report. This automatic generation of reports enables health-care providers to more easily comply with government and local health-care reporting requirements. Based on the accumulated data received from fall-detecting devices and external sources, the system and methods disclosed calculate fall-risk assessments for each patient, enabling the health-care provider to more accurately predict falls to prevent such fall-related activities and/or minimize resulting injuries.

### PRIORITY CLAIM

This application is a non-provisional application of, claims priority to, and claims the benefit of U.S. Provisional Patent Application Ser. No. 60/916,471 filed on May 7, 2007, which is incorporated in its entirety herein by reference.

### COPYRIGHT NOTICE

A portion of the disclosure of this patent document contains or may contain material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### TECHNICAL FIELD

The present disclosure relates in general to fall monitoring, and in particular to methods and apparatus for tracking and documenting fall-related activities to enable health-care providers to analyze an individual's fall history, efficiently document and report fall-related activity, provide more effective remote health-care services, and help prevent future fall-related activity, which can lead to injuries.

### BACKGROUND

Providers of either inpatient or remote health-care (e.g., home care) often classify certain individuals as being at a risk to fall or at a risk to suffer serious injury as a result of a fall. Preventing falls and providing effective, immediate assistance after every fall can be difficult, if not impossible. This is particularly true when individuals are monitored by staff that is responsible for managing multiple patients in a hospital, nursing home, or other inpatient setting or when individuals are being monitored remotely. Moreover, health-care providers face substantial documentation burdens if an individual under the care of the provider falls or engages in fall-related activity. Health-care providers thus seek to minimize activities which are likely to result in individuals falling and hurting themselves and injuries that occur when individuals fall in the absence of medical personnel and to reduce the burden of satisfying the applicable documentation requirements that follow a fall or fall-related activity.

Companies have developed fall-detecting devices to enable health-care providers (e.g., nurses, doctors, nurses' assistants, physicians' assistants, and/or other medical personnel) to have more time to meaningfully respond to fall-related events. Typically, such devices monitor certain activity of an individual and inform a health-care provider when the individual is performing a monitored activity. In response to this information, the health-care provider can theoretically provide more timely (and therefore more medically effective) assistance. In other words, a health-care provider may in some instances be able to prevent fall-related activity or otherwise assist the person using the fall-detecting device.

U.S. Pat. Nos. 6,611,783 and 7,127,370 disclose one such monitoring system. This system includes a monitoring device which monitors a patient's body position and detects when the patient is attempting to stand. When the monitoring device detects that the patient is attempting to stand, the monitoring device triggers an audible and visible alert, perceivable by the patient and one or more health-care providers, to assist the patient. Other devices, such as devices offered by The Posey Company, Stanley Senior Technologies, RN+ Systems, and other device manufacturers use various technologies to identify patient activities and to inform the patient and others within perceptible range that the patient is engaging in fall-related behavior.

Each of the monitoring devices described above does not address certain related issues. First, none of the described devices enables accurate fall-risk assessment. Though these monitoring devices may provide an immediate audible or visible alarm, such alarms simply indicate that at a given instant, an individual monitored by a fall-detecting device is attempting to stand or is otherwise engaging in a monitored activity. None of these systems enables the robust data-storage capabilities necessary to accurately assess fall-risk.

Moreover, the above-noted monitoring devices do not enable a care provider to generate fall reports and automatically populate data fields of fall reports or other required or customized documents with data captured by fall-detecting devices each time an individual falls or engages in fall-related activity that requires documentation. State-operated regulatory agencies and other organizations frequently require regular patient safety information reporting (e.g., Quality Improvement (QI) reporting or Joint Commission on Accreditation of Healthcare Organizations (JCAHO) reporting) for hospitals, long-term care facilities, home care, hospice, rehabilitation, and other health-care entities. These monitoring devices do not simplify these reporting requirements. Nor do known fall-detecting devices enable health-care providers to more efficiently manage a universe of individuals, such that an assessment of the aggregate effectiveness of care provided to the universe of individuals is easily ascertained.

Accordingly, a system is needed to enable accurate fall-risk assessments to be made based on an individual's history of fall-related events. A system is needed to enable automation, validation, and simplification of compliance with the reporting requirements imposed upon hospitals, long-term care facilities, or other health-care organizations. A system is further needed to enable simultaneous management of a universe of individuals to enable assessment of an aggregate level of care provided to this universe of individuals.

### SUMMARY

The system and methods described herein enable health-care providers to more adequately and accurately monitor, report, assess, and organize various health-care events for a plurality of individuals under their care. The health-care provider preferably provides inpatient care, but may also provide care to individuals living in their own homes or in remote care facilities. To facilitate this care, the health-care provider provides individuals who have a documented fall-risk (or individuals for whom a full fall-risk assessment is not completed and who therefore need a fall-detecting device to monitor their activity while an assessment is conducted) with a fall-detecting device that is installed proximately to the patient. Each fall-detecting device is configured to transmit or cause transmission of a message indicative of a monitored activity to a host device maintained by a care provider. Preferably, the host device creates a new data record when it receives a message from one of the fall-detecting devices. Additionally, if the message from the fall-detecting device is a patient fall alert, the host device generates a fall report and automatically populates certain fields of the fall report based on the data contained in the received message. This automatic report generation enables easier compliance with applicable health-care reporting standards. The host device also performs a plurality of fall-risk assessments based on the accumulated data representing each fall report and based on additional, user-entered data. These fall-risk assessments enable the health-care provider to more accurately predict when an individual will engage in fall-related activity and to take proactive steps to prevent such fall-related activity (and thus possible resulting injuries) and minimize injury caused if the individual does fall.

The disclosed system in one embodiment includes a plurality of fall-detecting devices provided to a plurality of monitored individuals (e.g., patients). The fall-detecting device provided to a patient may take any suitable form, including but not limited to a motion sensor, a pressure pad, and/or a position monitor. In one embodiment, the fall-detecting device is a device as disclosed in U.S. Pat. Nos. 6,611,783 and 7,127,370. This device includes a transmitter patch removably attached to a patient's body. In this embodiment, the transmitter patch is capable of determining the position of at least part of the patient's body relative to a horizontal plane. The devices provided to individuals under the care of health-care providers may also monitor the individual's motion or the opening and closing of certain doors or windows in the individual's room or home. In various embodiments, each device provided by a care provider to monitor an individual's activity sends or causes to be sent a plurality of messages to a host device indicating occurrences of monitored events.

The disclosed system in one embodiment also includes a host device configured to receive various types of messages transmitted by the plurality of provided monitoring devices. The host device is preferably configured to communicate with a plurality of fall-detecting devices by way of the Internet and/or another suitable network and to remotely receive messages indicative of sensed events from each of the devices. The messages received by the host device are referred to below as “fall alerts.” It should be appreciated that the term “fall alert” as used below refers not only to messages indicating monitored events, but also to messages indicating other events detected by a fall-detecting device such as a low battery event, manual intervention with an event monitoring device, or manual intervention with a receiver (e.g., a button push). The message received by the host device in one embodiment contains information about the sensed status or activity—including at least a unique identifier associated with the fall-detecting device—to enable the host device to correlate the message with an individual wearing the device.

The host device of the disclosed system in one embodiment creates and stores a unique database record for each individual using a monitoring device. Alternatively, the host device ensures that a unique database record has been previously created and stored for each individual. Each database record preferably corresponds to only one individual and includes at least one field containing a value correlating at least one monitoring device with the individual. For example, a database record associated with an individual may contain the individual's name and a serial number associated with the monitoring device used by the individual. The database record may also contain additional biographic information needed to provide effective health-care services to the individual. For example, the database record may contain demographic information such as name, age, location, vital statistics, medical information such as medications taken and medical concerns, and historical information such as past instances in which the individual has engaged in fall-related activities.

The host device preferably performs a plurality of calculations about an individual based in part on the information received in one or more messages indicative of one or more fall alerts. For example, in one embodiment the host device calculates a fall-risk assessment for an individual wearing a fall-detecting device. This calculation in one embodiment is based on a combination of factors. For example, this calculation in one embodiment is based on one or more of the individual's age, the individual's health condition, the individual's history of falls, the frequency of the individual's fall-related activity, the individual's lifestyle, the time of day, and the frequency with which the individual engages in monitored activities without assistance. The captured data, along with relevant historical activity reports, enable a health-care provider to more accurately assess the fall-risk of the individual.

Accurate fall-risk assessments enable caregivers to provide more medically effective service to individuals likely to engage in fall-related activities. For example, by knowing that a particular individual is particularly likely to engage in a fall-related activity, nurses may be particularly vigilant about that individual's activities. If the nurses know that such an individual generally wakes up at a certain time, and if the system and methods disclosed calculate that the individual is likely to engage in fall-related activity upon awakening, a nurse may station himself or herself near the individual's room shortly before the individual typically awakens. Knowing that an individual is likely to engage in a fall-related activity also enables health-care providers to provide fall tracking and documentation services to individuals living in remote care facilities or in their own homes. As the universe of data accumulated about an individual grows, fall-risk assessments generated become more accurate and enable health-care providers to more accurately predict whether an individual is likely to engage in fall-related activity. Thus, the unavoidable delay with which health-care personnel respond to unpredicted, monitored events occurring for patients at a location different from the health-care personnel becomes less critical, as such unavoidable delays should occur less frequently.

The host device of the disclosed system in various embodiments is configured to receive a message from the plurality of fall-detecting devices indicating that an individual has engaged in a fall-related behavior. Preferably, the host device stores data indicative of the event in a database record associated with the appropriate individual. For each received message representing a fall alert, the host device preferably requires certain minimal follow-up actions from a user. If the user fails to complete one or more of the follow-up actions within a predetermined period of time, the host device may remind the user to take the required action(s) at predetermined intervals until the action is taken. Thus, the system and methods disclosed ensure adequate provider attention to each fall alert.

The host device in various embodiments automatically generates certain local reports and populate certain data fields in those reports depending on the relevant local reporting agencies and authorities for a given health-care provider. For example, for each fall-related activity recorded, the host device may generate at least one report to be stored locally on the physical host device. The host device preferably populates as many fields in the at least one local report as possible with values contained in or obtainable from a signal sent by the receiver about the fall-related activity (e.g., time of fall, location of fall, device identifier) or with values obtainable from the database record corresponding to the individual who engaged in the fall-related event (e.g., the individual's name, location, age, and/or gender). Such reports enable efficient satisfaction of care-provider specific reporting requirements.

The host device disclosed herein in various embodiments also enables automatic population of data fields in certain standardized reports or forms required by governmental reporting agencies, other health-care agencies, or other bodies to which a health-care provider is required to report. The disclosed system in various embodiments automatically submits these reports or forms to a required reporting agency or entity by way of the Internet and/or other suitable network. Additionally, the reporting agency or entity may communicate with the host device by way of the Internet or other suitable network to provide information needed to comply with applicable reporting requirements. Automatically populating data fields and submitting such reports enables health-care providers to satisfy many regulatory reporting requirements more reliably and with substantially less user interaction.

Other objects, features and advantages of the system will be apparent from the following detailed disclosure, taken in conjunction with the accompanying sheets of drawings, wherein like numerals refer to like parts, elements, components, steps and processes.

### BRIEF DESCRIPTION OF THE DRAWINGS

FIG. 1 is a block diagram of an example fall-detection system as disclosed herein including a network of a plurality of devices for sensing fall-related activities and a host device for tracking and documenting fall-related activities.

FIG. 2 is a more detailed block diagram showing one example of a host device as disclosed herein.

FIG. 3 is a flow chart illustrating an example method for tracking and documenting fall-related activities.

FIG. 4 is a block diagram of example database records associated with a plurality of patients under the care of a health-care provider.

FIG. 5 is a block diagram of an example database record created to store data indicative of all fall-related event signals received by the host device.

FIG. 6 is a screen shot of an example set of fall-risk assessment questions.

FIG. 7 is a screen shot of an example method of displaying a patient's information based on the database records and the fall-risk assessments.

FIG. 8 is a screen shot of an example customized fall form.

FIG. 9 is a screen shot of an example set of possible user-generated reports generated by the host machine.

### DETAILED DESCRIPTION OF EXEMPLARY EMBODIMENTS

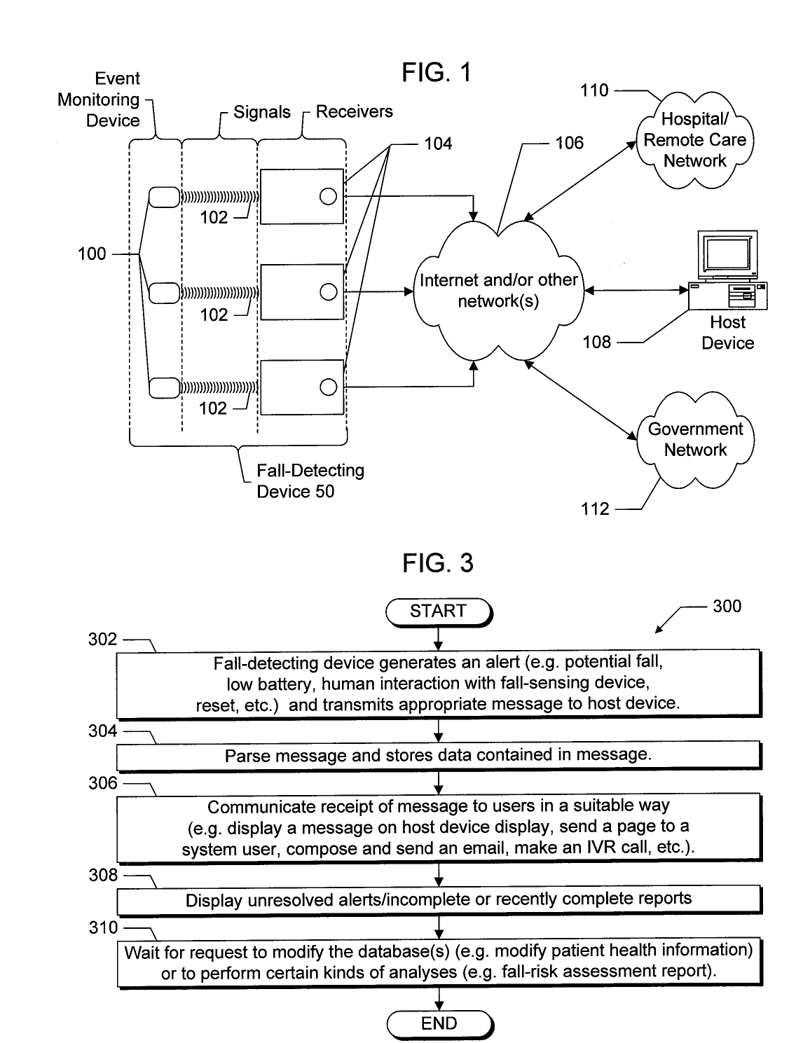

FIG. 1 is a block diagram of a plurality of fall-detecting devices 50 and the associated network elements included in an example implementation of the fall detection system as disclosed herein. Each fall-detecting device 50 of the illustrated embodiment includes an event monitoring device 100 configured to send a signal 102 to a receiver 104. The associated network elements enable tracking and documenting of fall-related events and enable the calculation of various indicators based on a plurality of sensed fall-related activities. A health-care provider provides individuals (e.g., patients) under its care with a fall-detecting device 50 as illustrated. Each fall-detecting device 50 may include an event monitoring device 100 capable of emitting a signal 102 indicating that the patient using the event monitoring device 100 is engaging in a monitored activity. The event monitoring device 100 may alternatively send a signal 102 including some other status message, such as a low-battery warning, manual intervention with the fall-detecting device 50 and/or other appropriate system conditions.

Preferably, each signal 102 indicating a fall alert or another system condition is received by an associated receiver 104. The receiver 104 may be configured to receive signals 102 from only one event monitoring device 100 or from multiple event monitoring devices 100. The signal 102 is preferably a wireless signal. For example, the signal 102 may be a Bluetooth® or other suitable wireless signal. Bluetooth® is a trademark owned by the Bluetooth SIG, Inc. and refers to a specification for maintaining wireless network connections. Alternatively, the signal 102 may be sent by a physical wire or cable and may be sent and received by an appropriate messaging protocol. Each signal 102 preferably includes a message identifier (not pictured) configured to indicate the type of system condition sensed. For example, the event monitoring device 100 may send a signal 102 including a distinct message identifier indicating a fall alert, low batteries, manual intervention with the event monitoring device 100, or other system condition. The signal 102 may contain a single message identifier indicating a single system condition. Alternatively, a signal 102 may include multiple message identifiers indicating multiple conditions, such as a fall alert and low batteries in the event monitoring device 100. It should be appreciated that the signal 102 may contain additional information such as time and date stamps and may in certain embodiments not include a message identifier.

In one embodiment, each fall-detecting device 50 communicates in a suitable way with the host device 108. Preferably, at least one receiver 104 is connected to at least one host device 108 by way of the Internet 106 to enable the host device 108 to receive and process information contained in messages indicative of signals 102 sent by the receivers 104. For example, a receiver 104 may be connected to a host device 108 by way of the Internet 106 to enable the host device 108 to receive messages indicative of monitored conditions sensed by a plurality of event monitoring devices 100. Multiple receivers 104 may be connected to the same host device 108 by way of the Internet or another suitable network 106 to enable the host device 108 to simultaneously receive messages indicative of monitored conditions from multiple event monitoring devices 100.

In one embodiment, a hospital/remote care network 110 is also connected to the host device 108 by way of the Internet or other network 106. In this embodiment, the network 106 enables the host device 108 to send information and submit reports electronically to the hospital/remote care network 110. A government network 112 may also be connected to the network 106, enabling host device 108 to send information and submit reports electronically to government network 112. The information sent by the host device 108 to the hospital/remote care network 110 and/or the government network 112 may include data, alerts, and/or reports, and is discussed in more detail below. Host device 108 may be configured to receive information sent by hospital/remote care network 110 and/or government network 112 over the Internet or other suitable network 108. Thus, if the information provided to the hospital/remote care network 110 and/or the government network 112 by the host device 108 is insufficient or needs to be supplemented, the hospital/remote care network 110 and/or the government network 112 may request additional information directly from the host device 108. For example, the hospital/remote care network 110 and/or the government network 112 may log in to the host device 108 and execute commands effectuating requests for additional information.

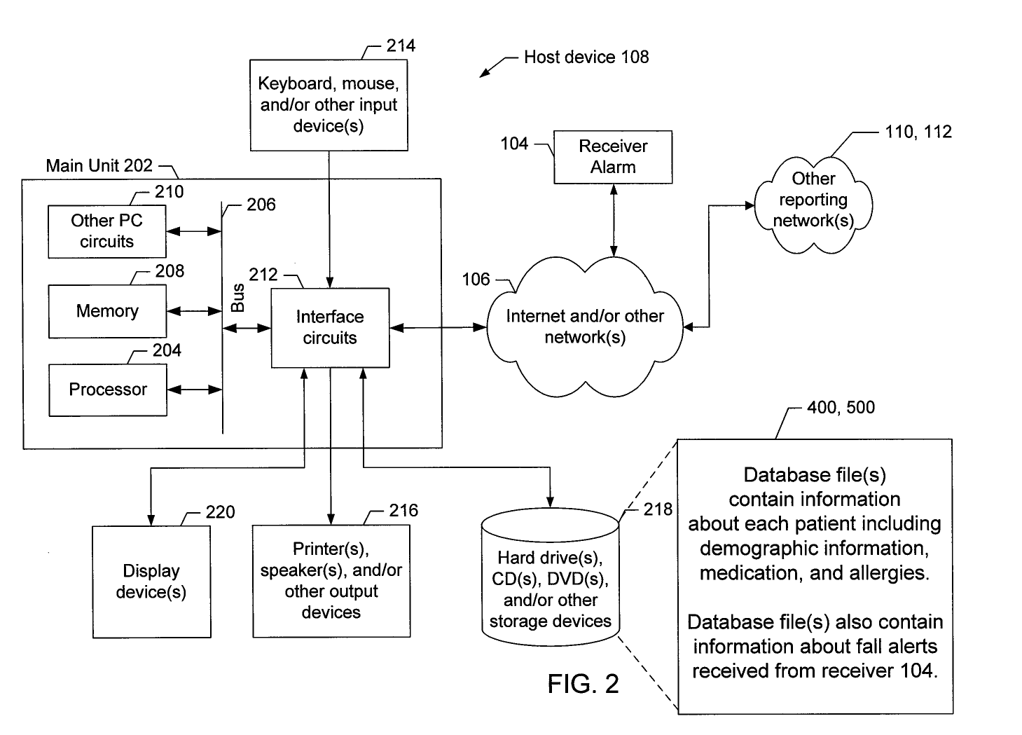

A more detailed block diagram of an example of the electrical systems of a host device (e.g., host device 108) is illustrated in FIG. 2. In the example architecture, the host device 108 includes a main unit 202 which preferably includes one or more processors 204 electrically coupled by an address/data bus 206 to one or more memory devices 208, other computer circuitry 210, and one or more interface circuits 212. The processor 204 may be any suitable processor, such as a microprocessor from the INTEL PENTIUM® family of microprocessors. PENTIUM® is a trademark registered to Intel Corporation and refers to commercially available microprocessors. The memory 208 preferably includes volatile memory and non-volatile memory. Preferably, the memory 208 stores a software program that interacts with the other devices in the system as described below. This program may be executed by the processor 204 in any suitable manner. The memory 208 may also store digital data indicative of documents, files, programs, web pages, etc. retrieved from a receiver 104 and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, and/or a voice recognition system.

One or more displays 220, printers, speakers, and/or other output devices 216 may also be connected to the main unit 202 via the interface circuit 212. The display 220 may be a cathode ray tube (CRT), liquid crystal display (LCD), or any other type of display. The display 220 generates visual displays of data generated during operation of the host device 108, such as those screen shots described below. For example, the display 220 may be used to display patient database records received from a host device. The visual displays may include prompts for human input, run time statistics, calculated values, data, etc. In one example described in more detail below, the display 220 may show a plurality patient characteristics indicative of a plurality of patients under the care of the health-care provider.

One or more storage devices 218 may also be connected to the main unit 202 via the interface circuit 212. For example, a hard drive, CD drive, DVD drive, and/or other storage devices may be connected to the main unit 202. The storage devices 218 may store any type of data used by the host device 108. In one example described in more detail below, the storage device 218 stores database information about the individuals under the care of the health-care provider and also stores information each instance of one of the individuals engaging in a fall-related activity, represented by a signal 102 received by receiver 104 and sent to host device 108 by way of the network 106.

The host device 108 may also exchange data with the hospital/remote care network 110 or the government network 112 using a connection to network 106. The network connection may be any suitable network connection, such as an Ethernet connection, digital subscriber line (DSL), telephone line, coaxial cable, etc. Access to a host device 108 may be controlled by appropriate security software or security measures. An individual user's access can be defined by the host device 108 and limited to certain data and/or actions. Accordingly, users of the system may be required to register with one or more host devices 108.

FIG. 3 is a flow chart of an example process 300 for tracking and documenting falls and other monitored activities and for tracking and documenting status messages sent by a plurality of fall-detecting devices 50. Although the example process 300 for tracking and documenting falls is described with reference to the flow chart illustrated in FIG. 3, it will be appreciated that many other methods of tracking and documenting falls are contemplated. For example, the order of many of the blocks may be changed, and many of the blocks described are optional.

Preferably, the example process 300 is implemented in software running on a host device 108. In a preferred embodiment, the software running on the host device 108 is implemented with a standard n-tier architecture by Oracle comprising one or more web servers, one or more application servers, and one or more database servers. Other suitable known and unknown architectures are also contemplated by the instant disclosure. Upon initiating the process 300, a fall-detecting device 50 detects a monitored event and transmits a message representing a fall alert to the host device 108 (block 302). For example, the alert and the message representing the alert may indicate that the event monitoring device 100 sensed a fall-related activity, that the battery in the event monitoring device 100 is low, that human interaction with the event monitoring device 100 or the receiver 104 occurred, and/or that the fall-detecting device 50 was reset.

Upon receiving the message representing the fall alert, the host device 108 captures the message and stores the data contained in the message in a database at an appropriate memory location (block 304). As discussed in more detail below, the host device 108 may store an indicator indicating the patient with whom the message is associated. The host device 108 may also parse the message and extract data representing various characteristics of the message. For example, the host device 108 may parse a received message representing a fall alert and remove a message identifier, a patient identifier, an alert time, and an alert date. The host device 108 may also generate information locally to supplement the data contained in the message indicating a fall alert. For example, the host device 108 may generate a value indicating whether the fall alert has been resolved, may insert the time and/or date the message was received, and/or may retrieve previously stored information providing further details about the patient using the fall-detecting device 50 or about the fall-detecting device 50 itself from which the message was received.

The host device 108 communicates the receipt of a message representing a fall alert to a user of the host device 108 (block 306). For example, the host device 108 may display a message on the display of the host device 108, may send a page to a user or other individual employed by the health-care provider, may compose and send an email to a responsible party, and/or may make an Interactive Voice Response (IVR) call. The communication from the host device 108 to a user may include a suitable representation that the host device 108 has received an indication from a receiver 104 that an event monitoring device 100 has detected that an individual has engaged in fall-related behavior. For example, the message indicating the fall alert may take the form of a popup window displayed in the Graphical User Interface (GUI) of host device 108, an audio signal indicating to a user that a fall-related activity has been detected, a flashing or otherwise highlighted icon on the GUI, or any other suitable representation.

After properly notifying a responsible party that a message indicating a fall alert has been received by the host device 108, the host device 108 displays unresolved fall alerts, incomplete reports, and/or recently completed reports to a user (block 308). For example, if the host device 108 previously prompted a user to generate and begin to fill out a report in response to a message indicating a fall alert, the host device 108 may prompt the user to ensure that the fall report is properly completed and submitted to the appropriate party. The host device 108 may prompt the user to submit the fall report electronically by way of the Internet or other suitable network 106 to a government reporting agency by way of the government network 112. The host device 108 may alternatively indicate to the user that a hospital/remote care network 110 or a governmental network 112 has recently sent data to the host device 108 including additional information to be stored in the host device 108 and used to complete a fall report. In this example, the host device 108 may further prompt the user to take action to ensure that the data is properly incorporated into the correct reports. In still another example, the host device 108 may display a message to a user informing the user that the host device 108 has received additional information from a hospital/remote care network 110 or a government network 112 and has inserted the information into one or more fall reports or otherwise stored the information.

Finally, the host device 108 waits for a request to modify the database or to perform certain kinds of analysis (block 310). For example, the host device 108 may provide a GUI that enables a user to alter the database of individuals being monitored by the health-care provider, perform one of a plurality of calculations, and/or generate one of a plurality of reports. The GUI may enable the user to modify patient health information and/or add an individual to the database. Individuals may be added to the database one at a time, or multiple individuals may be added simultaneously. The user may in another example request that the host device 108 generate a fall-risk assessment report about a particular patient. The user may also request that the host device 108 generate and automatically populate certain data fields in a report. Potential alterations to the database, potential calculations, and potential reports are discussed in greater detail below.

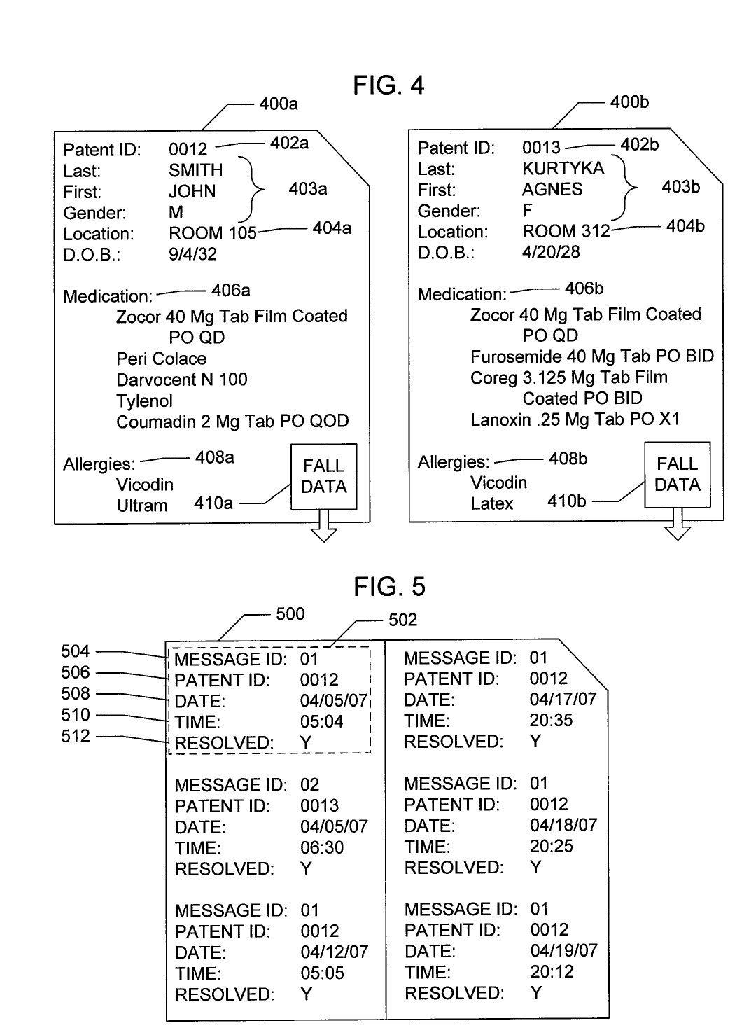

FIG. 4 illustrates an example of the database described with reference to FIG. 3 (block 304). The host device 108 stores a database record 400a or 400b corresponding to each patient being monitored by an event monitoring device 100. For example, if a health-care provider is monitoring and tracking two individuals, John Smith and Agnes Kurtyka, the host device 108 may store database records 400a and 400b about John Smith and Agnes Kurtyka, respectively. Each database record 400a and 400b may include information about the individual that enables the health-care provider to adequately monitor and track fall-related behavior. For example, each database record 400a and 400b may include a unique patient identifier 402a and 402b, the individual's personal identification information including name age, and gender 403a and 403b, the individual's location 404a and 404b, the individual's medications 406a and 406b, and allergies suffered by the individual 408a and 408b.

The individual's database record 400a or 400b may also contain a reference to the individual's fall data 410a and 410b. In one example, reference 410 is a pointer to a separate table containing information about each fall-related event detected by an event monitoring device 100 for all of the individuals being monitored by the health-care provider. References 410a and 410b may contain a method call that takes as an argument a reference to the individual about whom fall data is requested and performs a database query on the table containing all the fall information for the fall tracking and monitoring system. References 410a or 410b may be pointers to another database record distinct from database records 400a and 400b containing fall information solely about the individual from whose database record 400a or 400b the reference 410a or 410b originates. The data about an individual's past fall-related behavior may be stored within each patient's unique database record 400a or 400b.

FIG. 5 illustrates an example implementation of a database record 500 containing information about each monitored activity detected by a fall-detecting device 50 connected to the host device 108 by way of the Internet or other network 106. For example, each time an individual engages in fall-related activities, a fall alert may be generated indicating the fall-related activity. When the host device 108 receives each message indicative of such fall alerts, the host device 108 may store the data contained in the message in database record 500. Database record 500 may include one or more database entries 502, with each database entry 502 containing information about a discrete message indicating a fall alert received from a receiver 104. In the example database record 500 illustrated by FIG. 5, the host device 108 stores data included in messages indicative of fall alerts serially. Thus, when an event monitoring device 100 detects that an individual monitored by a fall-detecting device 50 connected to the host device 108 has engaged in a fall-related activity and sends an appropriate signal 102 to a receiver 104, receiver 104 communicates the fall-related activity to host device 108, and a new database entry 502 is created and stored in the single database record 500 containing information about the newly-detected fall-related activity.

In the illustrated example, the host device 108 stores each fall alert as a database entry 502 including a message identifier 504, a patient identifier 506, a fall-related event time 508, a fall-related event date 510, and a resolved field 512. The message identifier may indicate, among other things, the type of fall alert represented by the received message. For example, the message identifier 504 may indicate that the fall alert represents a fall-related activity, a low-battery alert, an alert indicating manual manipulation of the receiver 104, or other suitable type of fall alert. The message representing the fall alert may in other examples include additional information such as an event timestamp field, a transmission timestamp field, a resolved date field, and/or a resolved by field. In these embodiments, the host device 108 preferably parses the message and stores the data in the appropriate field in database entry 502.

The host device 108 may populate the message identifier field 504 when the host device 108 creates a database entry 502 for a new fall event. The host device 108 may also populate the resolved field 512 when the host device 108 creates a database entry 502. In addition, the host device 108 may by default initially populate the resolved field 512 with the value “N,” indicating that the fall-related event has not yet been resolved. One or more of the fields in database entry 502 may not be populated in each new database entry 502. The host device 108 may determine the fall-related event time 508 and fall-related event date 510 based on the host device's 108 system date and time at the instant the signal was received. Alternatively, the fall-related event date 510 may be contained within the signal sent by the event monitoring device 100. The host device 108 may populate the patient identifier field 506 with data received from the fall-detecting device. Alternatively, a received message indicating a monitored event may not include a patient identifier 506. It should be appreciate that in this embodiment, the host device 108 may determine a patient identifier 506 indicating the patient with whom the monitored activity is associated based on the fall-detecting device identifier included in each received message. The host device 108 may perform a lookup in a separate, locally stored table which includes a plurality of correlated fall-detecting device identifiers and patient identifiers. If such a message received from a fall-detecting device does not include a patient identifier, it should be appreciated that the message is substantially more secure and substantially less prone to tampering if intercepted.

Alternatively, the database entries 502 may not be stored serially, but rather may be organized by storing each database entry 502 sorted by message identifier 504, by fall-related event date 508 and time 510, by the resolved field 512, by another field included in a database entry 502, or by some other organization parameter. A separate database record 500 may be associated with each patient indicating that patient's history of fall-related behavior.

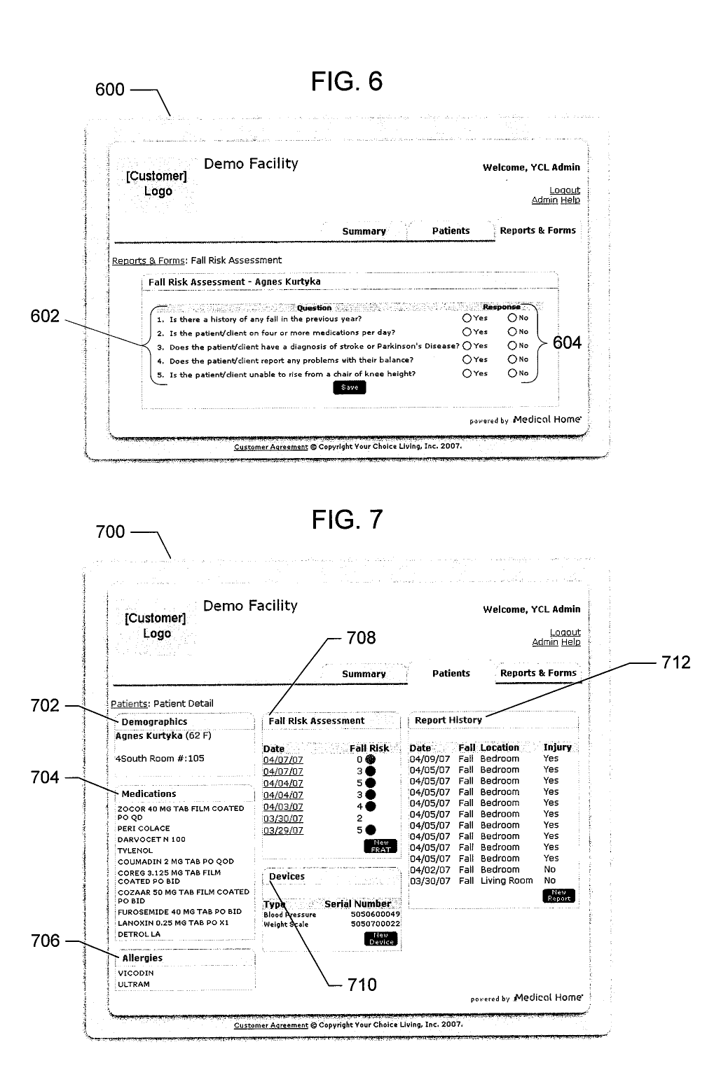

It should be appreciated that by tracking patients' histories of engaging in fall-related behavior, the host device 108 enables accurate calculation of fall-risk assessments. FIG. 6 illustrates a screen shot 600 of a sample fall-risk assessment performed for individual Agnes Kurtyka. The host device 108 may require the health-care provider to answer a series of questions about the individual for whom a fall-risk assessment is to be performed. The host device 108 may then calculate a fall-risk assessment value by combining the health-care provider's answers to questions 602 with an individual's history of engaging in fall-related behavior, stored in database record 500. As the host device 108 compiles a larger and larger universe of data indicating fall alerts sensed by fall-detecting devices 50 monitored by the host device 108, the accuracy of the host device's 108 predictions about the fall-risk for an individual typically increases.

The fall-risk assessment may in one example be based on the quantity of fall-related behavior that occurred during a given time period. For example, assuming identical responses to questions 602, an individual who has engaged in fall-related behavior twice in one week may be at a higher fall-risk than an individual who has only engaged in fall-related behavior once in a week. The fall-risk assessment may be calculated based partly on the time of day for which the fall-risk assessment is performed. For example, if an individual has engaged in fall-related behavior five times in a week but has only done so while getting out of bed in the morning (e.g., between the hours of 05:24 and 05:31), the individual's fall-risk may be calculated differently at 05:30 than at 14:30 on the same day. The health-care provider answers 604 may also be combined with the history of fall-related activities contained in record 500 in other suitable ways to arrive at a fall-risk assessment.

The health-care provider may use the fall-risk assessment values in a number of ways to provide more effective care to many individuals. First, the health-care provider may calculate certain times during the day that an individual living in an inpatient care facility is more likely to engage in a fall-related activity. At these times of the day, the health-care provider may increase or ensure personal contact with the individual, to avoid the highly likely fall-related behavior. Even within a single inpatient facility, accurate fall-risk assessments enable health-care providers to determine the ideal location for each individual's room, such that those individuals with a relatively high fall-risk are relatively closer to nurses' stations or other staffed health-care offices. Accurate fall-risk assessments also enable health-care providers to more efficiently generate schedules for each individual health-care provider. For example if individuals under the care of the inpatient health-care provider are more likely to engage in fall-related behavior at certain times of days, shifts, rounds, or stations may be staffed to support the increased fall-risks.

In addition, more accurate fall-risk assessments enable more accurate determination of those individuals for whom it is safe to live in a home without constant supervision of the health-care provider and more accurate determination of those individuals for whom living in an inpatient care facility is likely necessary to prevent serious injury. Fall-risk assessments enable health-care providers to more accurately determine when an individual who had previously been living in his or her own home, without constant supervision, needs to be transferred to an inpatient care facility due to an unacceptably high fall-risk assessment. Fall-risk assessments also enable family members to ensure that when fall-risks are unusually high, the individual wearing the fall-detecting device 50 is not alone.

In one embodiment, not illustrated in FIG. 6, each calculated fall-risk assessment value is stored in database record 400a or 400b associated with each individual being monitored by the health-care provider. Alternatively, the actual fall-risk assessment value may not be stored but rather a number representing the answers provided to the risk assessment questions 602 may be stored in database record 400a or 400b for each individual being monitored by the health-care provider. The questions may not need to be answered anew each time a fall-risk assessment value is calculated—the number representing the answers to the questions 602 may be combined in a predetermined way with an individual's then-existing history of engaging in fall-related behavior.

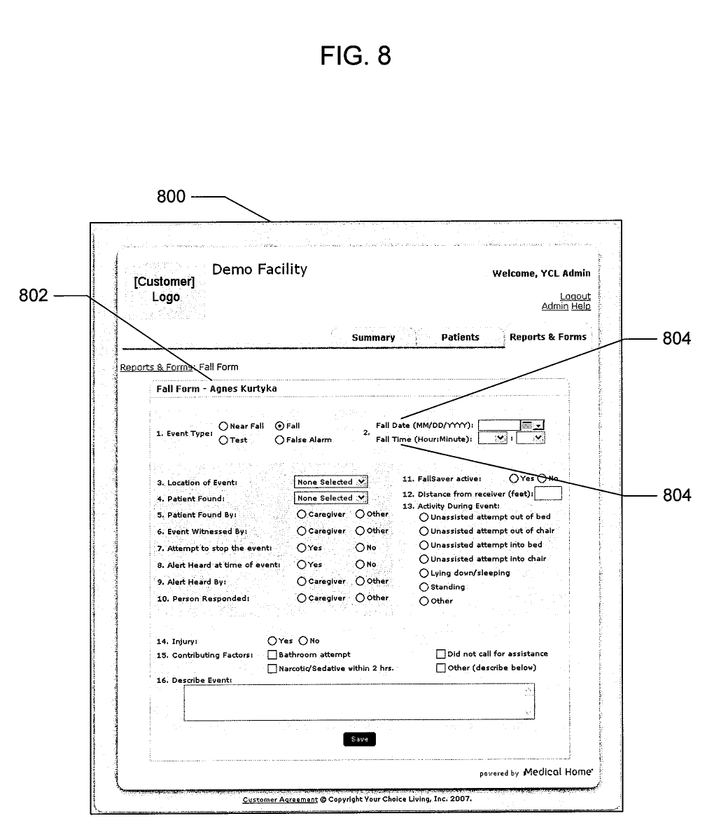

Referring to FIG. 7, it should be appreciated that the information contained in the database records 400a, 400b, and 500 and the fall-risk assessment values generated based on fall history and the questions 602 answered by the health-care provider form the basis for host device 108 to generate a summary of known information about a given individual being monitored by the health-care provider. In one example host device 108 displays a summary screen 700 for each individual containing demographics information 702 including name and location, medications taken 704, allergies 706, a list of all fall-risk assessments 708, monitoring devices associated with the patient 710, and report history 712 containing a list of the patient's history of engaging in a fall-related activity, the interventions provided by the health-care provider, and injuries resulting from engaging in fall-related behavior. The information in the summary screen 700 may be updated as the patient's database records 400 and/or the fall history database record 500 is updated.

FIG. 8 illustrates an example of a report that is generated each time a receiver 104 detects that an individual wearing an event monitoring device 100 has engaged in a fall-related activity. Whenever event monitoring device 100 detects such fall-related events and sends a signal 102 to receiver 104, receiver 104 notifies host device 108 that one of the individuals wearing an event monitoring device 100 has engaged in a fall-related activity. Host device 108 then generates a customized fall report and populates various data fields in the report. For example, the host device 108 may display customized fall report 800. Fall report 800 may be populated with the patient's name 802, the fall-related event date 804, and the fall-related event time 806. When host device 108 automatically generates a fall report from a database entry 502, the resolved field in database entry 502 may be set to “N” indicating that user action is required. Until all the fields of a fall report 800 have been populated automatically and/or manually, database record 502 may contain a value of “N” in the resolved field. When the host device 108 detects that a user has adequately responded to all required fields in the fall report 800, host device 108 may update the resolved field of the corresponding database entry 502. The resolved field may be automatically changed from “N” to “Y” to indicate that the user has adequately completed the fall report. Host device 108 may provide the user with a warning when at least one database entry 502 in database 500 indicates that at least one fall report 800 has not been totally resolved.

Once database entry 502 indicates that the fall report 800 has been adequately resolved, host device 108 may generate and format the data contained in the fall report 800. For example, the data contained in the fall report 800 may be used to populate data fields in a set of standard forms required for government reporting. As a result, compliance with regulatory reporting requirements is automated. Data used in the fall report 800 may also be used to populate standard hospital and/or other medical facility fall reports. This enables easier quality improvement reporting by comporting with standard reporting practices. In one example, the host device 108 may also enable a customized fall report 800 to be generated and filled out for an individual not wearing an event monitoring device 100 or using a fall-detecting device 50 who has fallen, nearly fallen, or engaged in fall-related behavior.

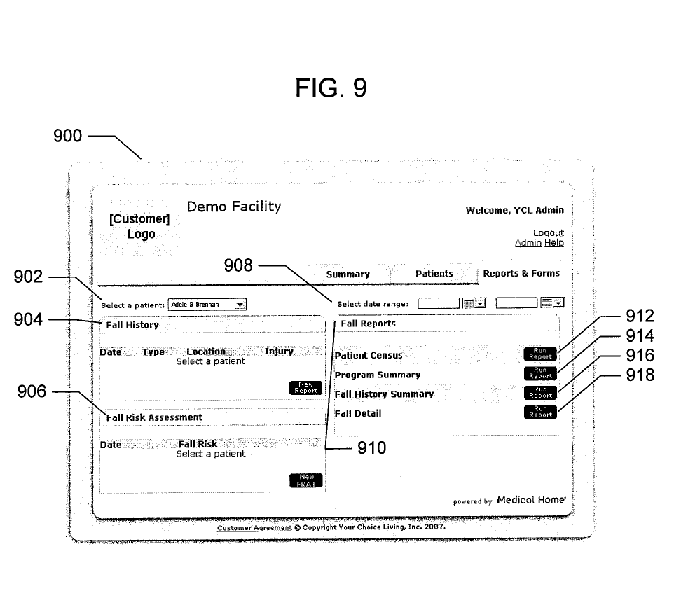

Referring to FIG. 9, the host device 108 also provides the user with a Graphical User Interface (GUI) that enables the user to generate a number of reports about a single individual being monitored by an event monitoring device 100 or about the universe of individuals being so monitored by a health-care provider. In one example GUI, represented by screen shot 900, host device 108 enables a user to select a patient 902 from a list of individuals, each individual having an associated database record 400, about whom to generate reports. The user may request that the host device 108 generate a fall history report 904, at which point the host device 108 may query fall-related event database record 500 and may retrieve all information pertaining to the selected patient 902. Similarly, the user may request that host device 108 generate a report of all fall-risk assessments performed for a given individual 906, at which point the host device 108 generates a listing of all fall-risk assessments contained in a given individual's database record 400.

For a given date range 908, host device 108 enables a user to select one of a plurality of fall reports 910. When the user selects one of these reports, the host device 108 generates the appropriate report and returns the result to the user. For example, a user may select and the host device 108 may run a census report 912, whereby for a given date range a summary of the individuals under the care of the health-care provider is generated. Alternatively, a user may select and the host device 108 may provide a program summary 914, whereby a report of the aggregate fall-related events for each individual under the care of the health-care provider is generated (e.g., the number of fall-related events, the percentage of patients who suffered fall-related events, or the severity of injuries resulting from falls). A user may select and the host device 108 may run a fall history summary 916, whereby all fall-related events for all patients are summarized based on date, time, patient name, and severity. More information about each fall-related activity may be provided, such as location, response time, responding party, activities undertaken at fall time, or another suitable fall-related event attribute. Finally, a user may select and the host device 108 may run a fall detail report 918, whereby for a given range of dates 910, a detailed listing of fall-related events may be provided based on information contained not only in the fall-related event database 500 but also in each customized fall report 800 filed by a user of the host system 108. It will be appreciated that other reports are contemplated by the system and methods disclosed herein, including reports in which a user is enabled to select any of the attributes stored in any database record 400a or 400b for any individual, fall-related event, or fall report.

It should be appreciated that the disclosed host device, when connected to one or more fall-detecting device 50, enables a health-care provider to determine a number of characteristics of fall-related events that are not ascertainable without the host-device disclosed herein. For example, the disclosed system may monitors, records, and generates reports for events that are not falls. The disclosed system may monitor a fall-detecting device 50 detecting that an individual attempted to stand. Upon entering the individual's room, a health-care provider may determine that the individual is safely sitting and that the individual did not fall. Based on this, the health-care provider may determine that the alert received by the host device 108 merely indicated an attempted stand, and further indicates that the individual safely sat down after attempting to stand.

Similarly, since the disclosed system may receive a message for each event detected by a fall-detecting device 50, the disclosed system enables a health-care provider to determine relevant details of a fall not otherwise ascertainable. The disclosed system may enable a health-care provider to determine whether an individual who fell out of bed rolled out of bed while sleeping or attempted to stand and fell during standing. For example, if a health-care provider determines that an individual fell, the disclosed system may not have received an alert indicating the individual attempted to stand. In this example, the lack of an indication that the individual attempted to stand may indicate that the individual fell from a supine position—that is, that the individual rolled out of bed.

It should be appreciated that the disclosed system enables various other determinations about one or more conditions of a fall or one or more events leading up to a fall. It should be further appreciated that the recording of each of any alerts sent by a fall-detecting device 50 may enable a health-care provider to be certain not only when fall-related events occurred, but also when fall-related devices did not occur, thus enabling adjustments to care of an individual based on the detailed fall history for that individual, including the circumstances surrounding each fall.

The disclosed system also enables robust automatic reporting. For example, the disclosed system may create at least a minimal report for each appropriate message received from a fall-detecting device 50 connected to the host device 108. This report may at least be populated with data included in the message received by the host device 108, such as information about the fall-detecting device 50 from which the message was received and data indicating the sensed event. Moreover, when the disclosed host device 108 generates such a report, the host device 108 may also populate that report with data stored in the disclosed database about the individual wearing or otherwise using the fall-detecting device 50. For example, the report may include at least basic biographic information such as name, date of birth, and physical location.

The disclosed system also enables customization of generated reports based on the facility using the disclosed system. For example, a report disclosed herein may be automatically populated with location-specific or facility-specific information, such as information about the room of a facility in which an individual is staying or information about the facility itself. The host device 108 may populate the generated report with this data to aid internal tracking of service quality or to facilitate compliance with external (i.e., governmental or other supervising entity) reporting requirements.

If the message received from the fall-detecting device 50 indicates that an individual has fallen or has otherwise engaged in a high fall-risk behavior, the disclosed system may automatically generate a fall incident report. The fall incident report may contain additional information not included in the generic report created for each relevant message received. For example, the fall incident report may include information about an individual's history of falling, information about the individual's risk of falling, information about the individual's risk of suffering injury from a fall, information about health concerns particularly relevant to handling a fall (i.e., if a patient is on a particular medication or has suffered particular injuries in the past), or other information particularly relevant to reporting a fall incident.

The disclosed system may enable a plurality of reports to be generated regardless of whether a fall-detecting device 50 has detected a fall. The system may enable an operator to trigger the generation of these reports—that is, an operator may request that a report be generated at any time based on data stored in the database of the disclosed system. The reports which may be so generated may include a fall history report, a fall-risk assessment report, a patient census, a program summary, a fall history summary, and a fall detail report. More specifically, the fall history report may include information for an individual patient or a plurality of patients documenting a history of falls or high fall-risk activity. This report may contain relatively high-level information such as time, date, and comments by a health-care provider which are stored in the database. The fall-risk assessment report may also be generated about one or more patients. For example, a fall-risk assessment report about all the patients in a wing of a health-care facility may include a list of calculated fall-risk assessments stored in the database, indicating a fall risk or a risk of suffering serious injury from a fall for each individual in the wing. A patient census may contain biographic information about each of a plurality of patients in a facility or under the care of a care provider. This biographic information may include information such as name, age, medical history, current medications, and physical location. The patient census may also include information about which sensor(s) the individuals are using/wearing. A program summary may be similar to a patient census but may include more high-level information about the overall effectiveness of a fall prevention and handling program implemented by a health-care provider. For example, a program summary may include calculations about response time, response effectiveness, and/or follow-up effectiveness to fall-related behavior. The program summary may also contain compliance information about a facility or location's compliance with various governmental or other supervisory authority standards. The program summary may further contain any relevant information about the overall effectiveness of a fall-related program. A fall history summary may include information about the fall-related activity history of one or more individuals monitored by a fall-detecting device 50. For example, a fall history summary may include data about each fall suffered by an individual, including information about time of day, circumstances surrounding the fall-related activity, and follow-up information such as treatment for injuries and cause analysis performed by the health-care provider. Finally, a fall detail report may include as much detail as possible (i.e., all data stored in the database) regarding a particular fall or set of falls. The fall detail report may relate to a particular patient or a group of patients, and may relate to all patients cared for by the health-care provider. For example, a fall detail report may include all relevant details about a particular fall, or may include all relevant details about all falls occurring during a certain shift of nurses or other health-care staff.

The disclosed system may also generate professional staff alerts or professional staff alerts. These reports and alerts may be directed to the performance of the health-care provider staff. For example, a professional staff report may include data about some or all of the staff of a health-care provider, including data about response time to fall alerts, data about effectiveness of care following a fall, data about patient satisfaction with staff, and/or data about staff compliance with governmental or other supervising entity requirements. This report may be automatically populated with various data such as data about the facility or location wherein the fallen individual received care, biographic information about the individual, and information about the responding health-care provider staff. In various embodiments, a professional staff alert includes a message or other communication of information to some or all of the health-care provider staff indicating that an individual has fallen and that the individual needs assistance.

Upon receiving a message indicating that an individual has triggered a fall-detecting device 50 message, the disclosed system may also retrieve and utilize population data stored in the disclosed database. In one embodiment, this population data may include aggregated fall data such as data about the overall effectiveness of staff response, data about an overall number of falls during a certain time period (e.g., between 4:30 and 6:30 in the morning), and/or data about overall compliance with governmental or other supervising entity standards. This population data may be indicative of a characteristic of a plurality of individuals, such as an average age, an average health condition, an average number of falls, a total number of falls, or some other relevant characteristic of the plurality of individuals.

The disclosed system may be further configured to generate one or more population reports indicating an overall quality of care provided by the health-care provider. For example, the disclosed system may store data about a plurality of individuals wearing or otherwise using one or more sensing devices such as fall-detecting device 50. The system may also be configured to retrieve external source data from a source such as an internet-accessible database. The system may compare the external source data to the population data stored over time to determine various characteristics indicative of the quality of care provided. For example, the host device 108 may be configured to compare a total number or rate of falling with an externally retrieved average total number of falls or rate of falling to determine an overall effectiveness of handling and responding to falls. It should be appreciated that the host device 108 may compare stored data with external data in any suitable way to provide useful analysis and feedback to the health-care provider.

In summary, a system and methods for tracking and documenting fall-related activities have been provided. The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method of documenting fall-related activities, the method comprising:
(a) storing a patient identifier in association with a fall-detecting device identifier, the fall-detecting device identifier identifying a fall-detecting device and the patient identifier identifying an individual associated with the fall-detecting device;
(b) receiving a message from the fall-detecting device, the message including the fall-detecting device identifier;
(c) storing data indicative of the received message in association with the patient identifier based on the fall-detecting device identifier;
(d) automatically generating a report;
(e) populating the report with the data indicative of the received message; and
(f) populating the report with patient information based on the patient identifier, the patient information identifying at least one characteristic of an individual.

2. The method of claim 1, including populating the report with at least one of location-specific information and facility-specific information.

3. The method of claim 1, wherein the report includes a fall incident report.

4. The method of claim 1, including:
(a) receiving a plurality of messages from a plurality of fall-detecting devices;
(b) storing data indicative of each of the plurality of received messages;
(c) combining the data indicative of the plurality of received messages with external source data;
(d) determining a difference between the external source data and the data indicative of the plurality of received messages; and
(e) generating a population report about a plurality of individuals based on the difference between the external source data and the data indicative of the plurality of received messages.

5. The method of claim 1, including calculating a fall-risk assessment factor based on at least one of the data indicative of the received message and the patient identifier, the fall-risk assessment factor indicating at least one of an individual's risk of falling and a predicted injury severity.

6. The method of claim 5, including calculating the fall-risk assessment factor based on a time the message was received and based on an answer to a fall-risk assessment question.

7. The method of claim 1, wherein the patient information includes at least one of a patient name, a patient age, a patient location, a patient record number, and a patient health status.

8. The method of claim 7, wherein the patient health status includes at least one of physical condition, illnesses, medication type, dosage, frequency, and emergency contact information.

9. The method of claim 5, wherein the patient information includes at least one of a fall history and a fall-risk assessment factor.

10. The method of claim 1, wherein the report conforms to a standard report format determined by a government entity.

11. The method of claim 1, wherein the report conforms to a standard report format determined by a supervising medical care entity.

12. The method of claim 1, including generating at least one of a fall history report, a fall-risk assessment report, a patient census, a program summary, a fall history summary, and a fall detail report regardless of any received message.

13. The method of claim 1, including generating an alarm selected from the group including an audible alarm, a visual alarm, and a vibrating alarm in response to the message.

14. The method of claim 1, including determining that the individual attempted to stand and subsequently sat back down based on the data indicative of the received message.

15. The method of claim 1, including determining that the individual fell from at least one position selected from a group including a supine position and a prone position without attempting to stand based on the data indicative of the received message.

16. The method of claim 1, wherein if the message indicates that an individual fell, performing at least one of the actions selected from the group including:
(a) generating a professional staff report,
(b) generating a professional staff alert,
(c) populating the report with location-specific information,
(d) populating the report with facility-specific information, and
(e) retrieving population data, the population data being indicative of a characteristic of a plurality of individuals.

17. An apparatus for documenting fall-related activities, the apparatus comprising:
a host device configured to communicate with the plurality of fall-detecting devices, each of the plurality of fall-detecting devices having a unique fall-detecting device identifier:
wherein the host device is further configured to:
(a) store a patient identifier in association with each of the fall-detecting device identifiers, the patient identifier identifying an individual associated with each fall-detecting device
(b) receive a message from one of the plurality of fall-detecting devices, the message including the fall-detecting device identifier;
(c) store data indicative of the received message in association with the patient identifier based on the fall-detecting device identifier;
(d) automatically generate a report;
(e) populate the report with the data indicative of the received message, and
(f) populate the report with patient data based on the patient identifier.

18. The apparatus of claim 17, wherein the host device is configured to: populate the report with at least one of location-specific information and facility-specific information.

19. The apparatus of claim 17, wherein if the report includes a fall incident report.

20. The apparatus of claim 17, wherein the host device is additionally configured to:
(a) receive a plurality of messages from a plurality of fall-detecting devices;
(b) store data indicative of each of the plurality of received messages;
(c) combine the data indicative of the plurality of received messages with external source data;
(d) determine a difference between the external source data and the data indicative of the plurality of received messages; and
(e) generate a population report about a plurality of individuals based on the difference between the external source data and the data indicative of the plurality of received messages.

21. The apparatus of claim 17, wherein the host device is configured to calculate a fall-risk assessment factor based on at least one of the data indicative of the received message and the patient identifier, the fall-risk assessment factor indicating at least one of an individual's risk of falling and a predicted injury severity.

22. The apparatus of claim 21, wherein the host device is configured to calculate the fall-risk assessment factor based on a time the message was received and based on an answer to a fall-risk assessment question.

23. The apparatus of claim 17, wherein the patient information includes at least one of a patient name, a patient age, a patient location, a patient record number, and a patient health status.

24. The apparatus of claim 23, wherein the patient health status includes at least one of physical condition, illnesses, medication type, dosage, frequency, and emergency contact information.

25. The apparatus of claim 21, wherein the patient information includes at least one of a fall history and a fall-risk assessment factor.

26. The apparatus of claim 17, wherein the report conforms to a standard report format determined by a government entity.

27. The apparatus of claim 17, wherein the report conforms to a standard report format determined by a supervising medical care entity.

28. The apparatus of claim 17, wherein the host device is configured to generate at least one of a fall history report, a fall-risk assessment report, a patient census, a program summary, a fall history summary, and a fall detail report regardless of any received message.

29. The apparatus of claim 17, wherein the host device is configured to generate an alarm selected from the group including an audible alarm, a visual alarm, and a vibrating alarm in response to the message.

30. The apparatus of claim 17, wherein the host device is configured to determine that the individual attempted to stand and subsequently sat back down based on the data indicative of the received message.

31. The method of claim 17, wherein the host device is configured to determine that the individual fell from at least one position selected from a group including a supine position and a prone position without attempting to stand based on the data indicative of the received message.

32. The apparatus of claim 17, wherein if the message indicates that an individual fell, the host device is configured to perform at least one of the actions selected from the group including:
(a) generate a professional staff report;
(b) generate a professional staff alert;
(c) populate the report with location-specific information;
(d) populate the report with facility-specific information; and
(e) retrieve population data, the population data being indicative of a characteristic of a plurality of individuals.

33. A computer readable media storing software instructions to document fall-related activities, the software instructions causing a computing device to:
(a) store a patient identifier in association with each of a plurality of fall-detecting device identifiers, each fall-detecting device having a unique fall-detecting device identifier, wherein the patient identifier identifies an individual associated with each fall-detecting device;
(b) receive a message from one of the plurality of fall-detecting devices, the message including the fall-detecting device identifier;
(c) store data indicative of the received message in association with the patient identifier based on the fall-detecting device identifier;
(d) automatically generate a report;
(e) populate the report with the data indicative of the received message, and
(f) populate the report with patient data based on the patient identifier.
